(19) United States
(12) Patent Application Publication
(10) Pub. No.: US 2016/0217485 A1
(43) Pub. Date: Jul. 28, 2016

(54) SYSTEM AND METHOD FOR EMBEDDING A DISCOUNT OR COUPON CODE IN PERSONALIZED DIGITAL MEDIA

(71) Applicant: AUTOGRAPHY LLC, ST. PETERSBURG, FL (US)

(72) Inventors: Thomas J. Waters, St. Petersburg, FL (US); Robert N. Barrett, St. Petersburg, FL (US)

(21) Appl. No.: 15/006,193

(22) Filed: Jan. 26, 2016

Related U.S. Application Data
(60) Provisional application No. 62/107,767, filed on Jan. 26, 2015.

(51) Int. Cl. G06Q 30/02; G06K 9/00; G06K 9/18; G06K 9/62; G06K 9/52

(52) U.S. Cl. CPC G06Q 30/0222; G06Q 30/0225; G06K 9/6215; G06K 9/52; G06K 9/18; G06K 9/00442; G06K 9/00758; G06K 9/00288

(57) ABSTRACT

Disclosed are systems and methods for embedding an electronic discount within personalized digital media that is communicated to a user's media device and that is subsequently redeemable at a predetermined vendor.

### CROSS-REFERENCE TO RELATED APPLICATION

This application claims priority to U.S. Provisional Patent Application No. 62/107,767 filed on Jan. 26, 2015, the contents of which are incorporated by reference herein.

### TECHNICAL FIELD

The present invention relates generally to the field of embedding digital rewards in digital media, and more particularly, to embedding digital rewards in personalized digital media such as personalized autographs, audio, and/or video from a celebrity, athlete, musician, public personality, or any combination thereof that are subsequently redeemable at a vendor.

### BRIEF SUMMARY

Disclosed are methods and systems for embedding an electronic code (e.g., print, QR, audio, barcode, etc.) into personalized digital media for the purpose of rewarding a user (e.g., a fan). In certain aspects, the electronic code provides for free or discounted digital downloads, or may be used with a physical store for free or discounted physical merchandise. The personalized digital media is not damaged or in any way altered by the coding mechanism, and remains as a permanent memento of the fan's interaction with the celebrity (author, athlete, musician, actor, etc.).

Disclosed are systems and methods of embedding an electronic discount within personalized digital media, the systems and methods including: (a) communicating a request from a user's media device to a second media device associated with celebrity, a musician, an athlete, an author or any combination thereof thereby requesting personalized digital media from the second media device, wherein the personalized digital media includes at least one of a digital autograph, a personalized digital written message, a personalized audio recording, or a personalized video recording; (b) providing, with the second media device, the personalized digital media and embedding a unique discount code in the personalized digital media that is only once redeemable at a predetermined vendor; (c) communicating, by the second media device to the first media device, the requested personalized digital media with the embedded unique discount code and receiving with the user's media device the requested personalized digital media with the embedded unique discount code; (d) after step (c), providing the predetermined vendor with the requested personalized digital media with the embedded unique discount code to redeem a discount; (e) after step (d), verifying authenticity of the unique discount code by the predetermined vendor communicating the unique discount code to a database configured to verify authenticity of the unique discount code; and (f) upon verifying authenticity of the unique discount code, providing a user with the discount associated with the unique discount code.

In certain aspects, the unique discount code is at least one selected from the group consisting of a general bar code, a proprietary bar code, a quick response code, an audio signal, or any combination thereof.

In certain aspects, the unique discount code is visually displayed in the personalized digital media.

In certain aspects, the unique discount code is hidden in the personalized digital media.

In certain aspects, the personalized digital media includes a certificate of authenticity. The certificate of authenticity includes, in certain aspects, authenticity verification of the digital autograph or personalized digital written message of the generated by the celebrity, a musician, an athlete, an author or any combination thereof in which the digital autograph or personalized digital written message must achieve at least a 90% confidence level based on an X, Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 90% confidence level based on amplitude and frequency and/or facial recognition when compared to reference samples of the celebrity, musician, athlete, author or any combination thereof. In certain aspects, each of these confidence levels must achieve a 95% confidence level, preferably, a 95% confidence level, and more preferably a 99% confidence level. For example, the personalized digital media is a personalized video recording that must achieve at least a 99% confidence level based on amplitude and frequency and facial recognition when compared to reference samples of the celebrity, musician, athlete, author or any combination when verifying authenticity before embedding the unique discount code in the personalized digital media. Verifying authenticity preferably occurs before embedding the unique discount code in the personalized digital media.

In certain aspects, the systems and methods further include reporting to the second media device in real time once the user is provided with the discount associated with the unique discount code. The location, vendor name, and time of code redemption may be further provided to the second media device.

The vendor in the disclosed methods and systems may include an online retailer or brick and mortar retailer. In certain aspects, the vendor is an online retailer whereas in other aspects the vendor is a brick and mortar store.

In certain aspects, the discount associated with the unique discount code is for purchasing digital media, physical merchandise, or a combination thereof. For example, the unique discount code may be used for purchasing digital media from a brick and mortar retailer that is subsequently communicated to the user's media device. In another example, the unique discount code is used for purchasing digital media from an online retailer that is communicated in real time upon completion of the purchase to the user's media device.

In certain aspects, the unique embedded code may be a QR code, simple bar code, proprietary bar code, audio signal, video clip, or similar mechanism that can be delivered with the personalized digital media. The code can be embedded into the personalized digital media itself or as a separate file. The code can be delivered with the media (as an email attachment or text file in the email body) or sent separately depending on the preferred application. The code can be displayed obviously (text string in an email) or hidden within the personalized digital media (steganography), depending on the preferred application. The code can be set for one specific retail vendor (such as the celebrity's own website) or for any legitimate retailer with access to the code approving database in order to use it. The same code can be redeemed at several different retailers so that each code can appeal to numerous types of fans with different wishes, desires, and uses. Different code mechanisms can have specific applications; digital retailers like Amazon or Apple, or consumer stores such as McDonald's or Starbucks. But once the code is approved for use and cashed by any merchant it no longer works for any of the other approved vendors.

Each code is matched to a database that will allow only one-time use of each provided code from a prescribed piece of media. For example, a one-time code string of text (re: hdjcnagckllk) has one, and only one, use. Afterwards, any attempt to use this string of text code again will be unsuccessful, as the central computer will not approve the transaction. The personalized digital media remains with the user/consumer, but the one-time use code associated with that personalized digital media has now expired.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 depicts an exemplary system and method for receiving personalized digital media (ebook, photo, etc.) with an embedded one-time code;

FIG. 2 depicts an exemplary system and method of sending the personalized digital media to a database where the one-time code is added before being forwarded to a user's device;

FIG. 3 depicts an exemplary system and method of sending the personalized digital media with a one-time code to a user's device that is presented to a retailer for physical merchandise; and

FIG. 4 depicts an exemplary system and method for sending personalized digital media to a database where the one-time code is added to the personalized digital media and sent to the consumer's media device where it is presented to a retailer for physical merchandise.

### DETAILED DESCRIPTION

The present invention will now be described more fully hereinafter with reference to the accompanying drawings in which exemplary embodiments of the invention are shown. In particular, the present invention is described below with reference to block diagrams and operational illustrations of methods, systems, and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently. The invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Generally, in terms of hardware architecture for the electronic devices disclosed below, computing device includes a processor, a memory, and one or more input and/or output (I/O) devices (or peripherals) that are communicatively coupled via a local interface. Local interface may be one or more buses or other wired or wireless connections, as is known in the art. Local interface may have additional elements, which are omitted for simplicity, such as controllers, buffers (caches), drivers, transmitters, and receivers to facilitate external communications with other like or dissimilar computing devices. Further, local interface may include address, control, and/or data connections to enable internal communications among the other computer components.

The processor is a hardware device for executing software, particularly software stored in memory. The processor can be any custom made or commercially available processor, such as, for example, a Core series or vPro processor made by Intel Corporation, or a Phenom, Athlon or Sempron processor made by Advanced Micro Devices, Inc. In the case where computing device is a server, the processor may be, for example, a Xeon or Itanium processor from Intel, or an Opteron-series processor from Advanced Micro Devices, Inc. Processor may also represent multiple parallel or distributed processors working in unison. Processor may also represent multiple processors located in a plurality of computing devices working in parallel, unison, or serial effort to achieve the disclosed methods.

Memory can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic magnetic, optical, and/or other types of storage media. Memory can have a distributed architecture where various components are situated remote from one another, but are still accessed by processor. These other components may reside on devices located elsewhere on a network or in a cloud arrangement.

The software in memory may include one or more separate programs. The separate programs comprise ordered listings of executable instructions for implementing logical functions. The software in memory may include the system in accordance with the invention, and a suitable operating system (O/S). Examples of suitable commercially available operating systems are Windows operating systems available from Microsoft Corporation, Mac OS X available from Apple Computer, Inc., a Unix operating system from AT&T, or a Unix-derivative such as BSD or Linux. The operating system O/S will depend on the type of computing device. For example, if the computing device is a PDA or handheld computer (e.g., smartphone), the operating system may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system essentially controls the execution of other computer programs, such as the system, and provides scheduling, input-output control, file and data management, memory management, and communication control and related services.

If computing device is a PC compatible computer, Apple® computer, a handheld device, or the like, the software in memory may further include a basic input output system (BIOS). The BIOS is a set of essential software routines that initialize and test hardware at startup, start operating system, and support the transfer of data among the hardware devices. The BIOS is stored in ROM so that the BIOS can be executed when computing device is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, Swift, and Lua.

I/O device may include input devices such as a keyboard, a mouse, a scanner, a microphone, a touch screen, a bar code reader, or an infra-red reader. It may also include output devices such as a printer, a video display, an audio speaker or headphone port or a projector. I/O device may also comprise devices that communicate with inputs or outputs, such as a short-range transceiver (RFID, Bluetooth, etc.), a telephonic interface, a cellular communication port, a router, or other types of network communication equipment. I/O device may be internal to computing device, or may be external and connected wirelessly or via connection cable, such as through a universal serial bus port.

When the computing device is in operation, processor is configured to execute software stored within memory, to communicate data to and from memory, and to generally control operations of computing device pursuant to the software. The system and operating system, in whole or in part, may be read by processor, buffered within processor, and then executed.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system can be embodied in any type of computer-readable medium for use by or in connection with an instruction execution system or apparatus, such as a computer.

For purposes of connecting to other computing devices, computing device is equipped with network communication equipment and circuitry. In a preferred embodiment, the network communication equipment includes a network card such as an Ethernet card, or a wireless connection card. In a preferred network environment, each of the plurality of computing devices on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks. In certain aspects, standalone systems not requiring connectivity to other systems are also contemplated.

Disclosed are systems and methods of embedding an electronic discount within personalized digital media, the method including: (a) communicating a request from a user's media device to a second media device associated with celebrity, a musician, an athlete, an author or any combination thereof thereby requesting personalized digital media from the second media device, wherein the personalized digital media includes at least one of a digital autograph, a personalized digital written message, a personalized audio recording, or a personalized video recording; (b) providing, with the second media device, the personalized digital media and embedding a unique discount code in the personalized digital media that is only once redeemable at a predetermined vendor; (c) communicating, by the second media device to the first media device, the requested personalized digital media with the embedded unique discount code and receiving with the user's media device the requested personalized digital media with the embedded unique discount code; (d) after step (c), providing the predetermined vendor with the requested personalized digital media with the embedded unique discount code to redeem a discount; (e) after step (d), verifying authenticity of the unique discount code by the predetermined vendor communicating the unique discount code to a database configured to verify authenticity of the unique discount code; and (f) upon verifying authenticity of the unique discount code, providing a user with the discount associated with the unique discount code.

In certain aspects, the unique discount code is at least one selected from the group consisting of a general bar code, a proprietary bar code, a quick response code, an audio signal, or any combination thereof.

In certain aspects, the unique discount code is visually displayed in the personalized digital media.

In certain aspects, the unique discount code is hidden in the personalized digital media.

In certain aspects, the personalized digital media includes a certificate of authenticity. The certificate of authenticity includes, in certain aspects, verifying authenticity of the digital autograph or personalized digital written message of the generated by the celebrity, a musician, an athlete, an author or any combination thereof in which the digital autograph or personalized digital written message must achieve at least a 90% confidence level based on an X,Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 90% confidence level based on amplitude and frequency and/or facial recognition when compared to reference samples of the celebrity, musician, athlete, author or any combination thereof. In certain aspects, the certificate of authenticity includes, in certain aspects, verifying authenticity of the digital autograph or personalized digital written message of the generated by the celebrity, a musician, an athlete, an author or any combination thereof in which the digital autograph or personalized digital written message must achieve at least a 95% confidence level based on an X,Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 95% confidence level based on amplitude and frequency and/or facial recognition when compared to reference samples of the celebrity, musician, athlete, author or any combination thereof In certain aspects, the certificate of authenticity includes, in certain aspects, verifying authenticity of the digital autograph or personalized digital written message of the generated by the celebrity, a musician, an athlete, an author or any combination thereof in which the digital autograph or personalized digital written message must achieve at least a 99% confidence level based on an X,Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 99% confidence level based on amplitude and frequency and/or facial recognition when compared to reference samples of the celebrity, musician, athlete, author or any combination thereof For example, the personalized digital media is a personalized video recording that must achieve at least a 99% confidence level based on amplitude and frequency and facial recognition when compared to reference samples of the celebrity, musician, athlete, author or any combination when verifying authenticity before embedding the unique discount code in the personalized digital media. Verifying authenticity preferably occurs before embedding the unique discount code in the personalized digital media.

In certain aspects, the systems and methods further include reporting to the second media device in real time once the user is provided with the discount associated with the unique discount code.

The vendor in the disclosed methods and systems may include an online retailer or brick and mortar retailer. In certain aspects, the vendor is an online retailer whereas in other aspects the vendor is a brick and mortar store.

In certain aspects, the discount associated with the unique discount code is for purchasing digital media, physical merchandise, or a combination thereof. For example, the unique discount code may be used for purchasing digital media from a brick and mortar retailer that is subsequently communicated to the user's media device. In another example, the unique discount code is used for purchasing digital media from an online retailer that is communicated in real time upon completion of the purchase to the user's media device.

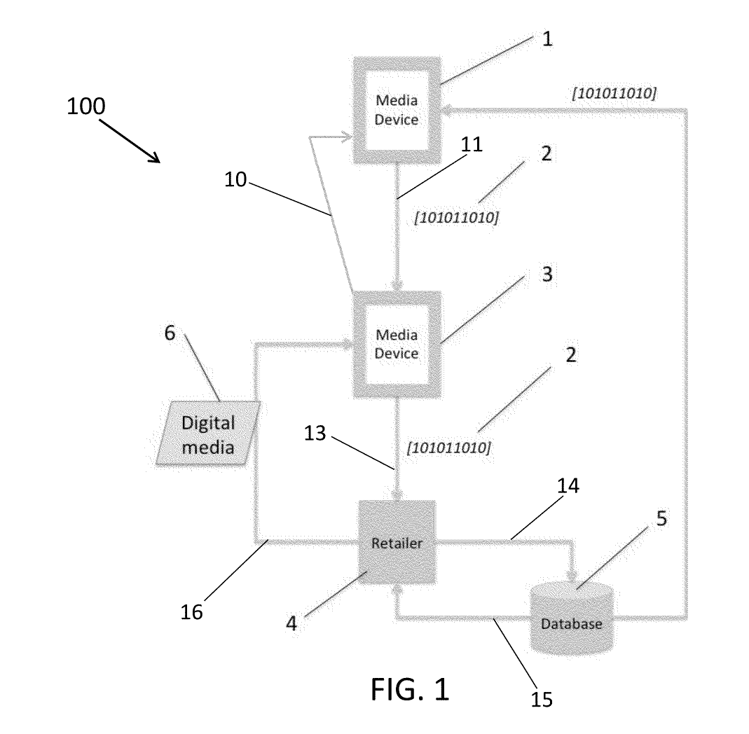

With specific reference to the FIGS. 1-4, the following reference numerals are used to indicate the parts and environment of the disclosed systems and methods:

100, 200—Exemplary systems configured to perform the disclosed methods;

1—The celebrity, musician, or author's interface device for personalizing digital media;

2—The embedded one time code (i.e., unique discount code);

3—A consumer's media device (e.g., smartphone, tablet, eReader, etc.), also referred to as a user's media device;

4, 40—Vendor, being a physical retail establishment (brick and mortar retailer) or online retailer respectively;

5—Database configured to verify/authenticate all one-time codes (i.e., unique discount codes);

6—Free or discounted digital media sent to the consumer (user);

10—Request from user's media device;

11—Communicating personalized digital media to database to embed unique discount code in personalized digital media;

12—Communicating personalized digital media with embedded unique discount code to user's media device;

13—Providing vendor with unique discount code for redeeming;

14—Vendor communicating unique discount code to Database for verifying authenticity;

15—Database communicating authenticity verification (whether unique discount code is authentic and redeemable) to Vendor; and

16—If unique discount code is authentic and redeemable, providing user with discount associated with unique discount code.

Referring to FIG. 1, a fan (user) sends a request 10 from their media device 3 to a celebrity, musician, or author's interface device/component 1 requesting personalized digital media with a one-time code 2 for free or discounted digital merchandise. An interface component 1 provides the mechanism for the celebrity, musician, or author to create personalized digital media for the fan. The personalized media is subsequently embedded with a one-time code 2 (unique discount code) and sent 11, 12 via computer network with a one-time code 2 (text, software, image, etc.) to the fan and is subsequently received on the fan's digital media device 3. The fan presents 13 the code 2 (with our without the personalized media) to a retailer 4 to potentially receive free or discounted digital media 6 (movie, ebook, music, etc.). Before providing discounted digital media or merchandise, the retailer communicates 14 the unique code to database 5 to verify the authenticity of the unique discount code and database 5 subsequently communicates to the retailer whether the code is authentic. Upon the retailer's successful confirmation of the one-time code's authenticity/validity through a central database 5, the digital media 6 is sent to the fan's digital media player 3, (or elsewhere at the fan's discretion).

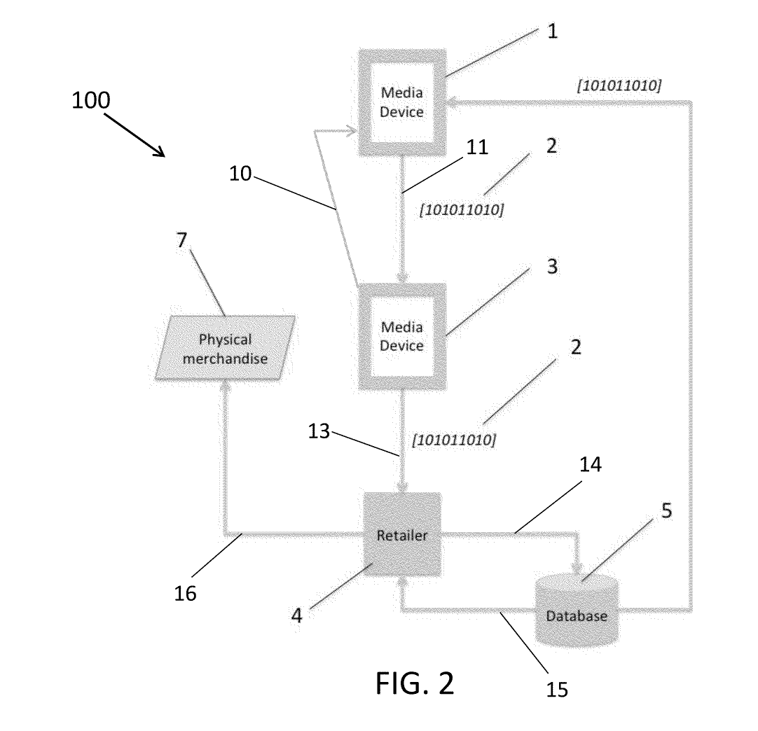

The methods and systems depicted in FIG. 2 are similar to those depicted in FIG. 1 except that the user ultimately redeems the unique discount code for physical merchandise 7 instead of digital media. Specifically, referring to FIG. 2, the personalized digital media is delivered at the time of purchase. An interface component 1 provides the mechanism for the personality to create personalized digital media for the fan. The media is sent via computer network with a one-time code 2 (text, software, image, etc.) that is received on the fan's digital media device 3. The fan presents the code (with our without the personalized media) to a retailer 4 to receive free or discounted physical merchandise. Upon the retailer's successful confirmation of the one-time code's validity through a central database 5, the physical merchandise 7 is given to the fan in person or mailed/shipped to the fan's address of choice.

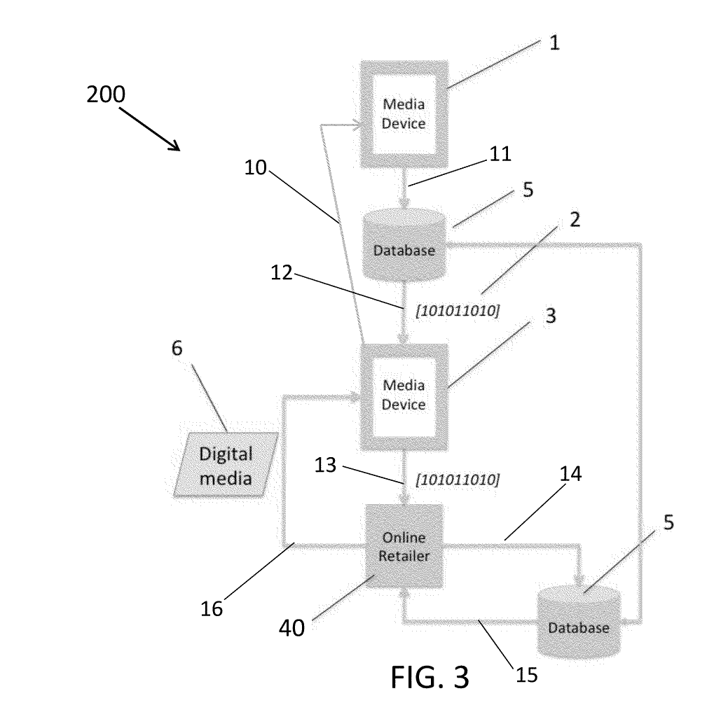

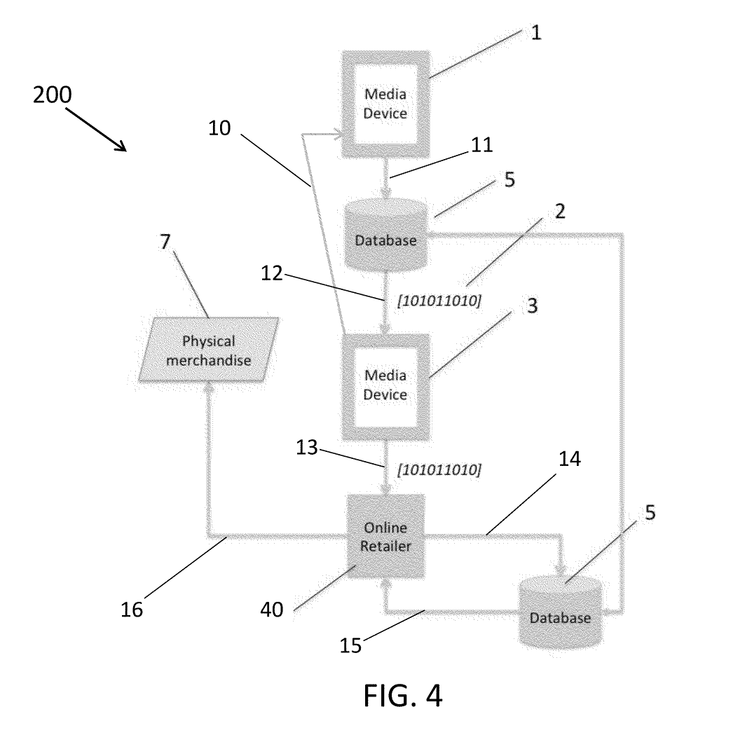

The methods and systems 200 of FIGS. 3 and 4 are similar to those depicted in FIGS. 1 and 2. The methods of systems 200 of FIGS. 3 and 4 further include database 5 that verifies authenticity of the personalized digital media and may further provide a certificate of authenticity. After verifying authenticity of the personalized digital media, the personalized digital media is subsequently embedded with the unique discount code 2 and communicated 12 to the user's media device 3. Specifically, referring to FIG. 3, the personalized digital media is sent to a database where the one-time code is added before being delivered to the consumer's device. An interface component 1 provides the mechanism for the personality to create personalized digital media for the fan. The media is sent via computer network to a central database 5 where a one-time code 2 is added and sent to the fan's digital media device 3. The fan presents the code (with our without the personalized media) to an online retailer 40 to receive free or discounted digital media (movie, ebook, music, etc.). Upon the online retailer's successful confirmation of the one-time code's validity through a database 5, (which may or may not be the same database that provided the one-time code above) the digital media 6 is sent to the fan's digital media player 3, (or elsewhere at the fan's discretion).

The methods and systems depicted in FIG. 4 are similar to those depicted in FIG. 3 except that the user ultimately redeems the unique discount code for physical merchandise 7 instead of digital media. Referring to FIG. 4, the personalized digital media is delivered at the time of purchase. An interface component 1 provides the mechanism for the personality to create personalized digital media for the fan. The media is sent via computer network to a central database 5 where a one-time code 2 is added and sent to the fan's digital media device 3. The fan presents the code (with our without the personalized media) to a retailer 40 to receive free or discounted physical merchandise. Upon the retailer's successful confirmation of the one-time code's validity through a database 5, (which may or may not be the same database that provided the one-time code above) the physical merchandise 7 is given to the fan in person or mailed/shipped to the fan's address of choice.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of embedding an electronic discount within personalized digital media, the method comprising:
(a) communicating a request from a user's media device to a second media device associated with celebrity, a musician, an athlete, an author or any combination thereof thereby requesting personalized digital media from the second media device, wherein the personalized digital media includes at least one of a digital autograph, a personalized digital written message, a personalized audio recording, or a personalized video recording;
(b) providing, with the second media device, the personalized digital media and embedding a unique discount code in the personalized digital media that is only once redeemable at a predetermined vendor;
(c) communicating, by the second media device to the first media device, the requested personalized digital media with the embedded unique discount code and receiving with the user's media device the requested personalized digital media with the embedded unique discount code;
(d) after step (c), providing the predetermined vendor with the requested personalized digital media with the embedded unique discount code to redeem a discount;
(e) after step (d), verifying authenticity of the unique discount code by the predetermined vendor communicating the unique discount code to a database configured to verify authenticity of the unique discount code; and
(f) upon verifying authenticity of the unique discount code, providing a user with the discount associated with the unique discount code.

2. The method of claim 1, wherein the unique discount code is at least one selected from the group consisting of a general bar code, a proprietary bar code, a quick response code, an audio signal, or any combination thereof.

3. The method of claim 1, wherein the unique discount code is visually displayed in the personalized digital media.

4. The method of claim 1, wherein the unique discount code is hidden in the personalized digital media.

5. The method of claim 2, wherein the personalized digital media includes a certificate of authenticity.

6. The method of claim 5, wherein the certificate of authenticity comprises verifying authenticity of the digital autograph or personalized digital written message of the generated by the celebrity, a musician, an athlete, an author or any combination thereof in which the digital autograph or personalized digital written message must achieve at least a 90% confidence level based on an X,Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 90% confidence level based on amplitude and frequency and/or facial recognition when compared to reference samples of the celebrity, musician, athlete, author or any combination thereof.

7. The method of claim 6, wherein verifying authenticity of the personalized digital media occurs before embedding the unique discount code in the personalized digital media.

8. The method of claim 5, wherein the personalized digital media is a personalized video recording that must achieve at least a 99% confidence level based on amplitude and frequency and facial recognition when compared to reference samples of the celebrity, musician, athlete, author or any combination before embedding the unique discount code in the personalized digital media.

9. The method of claim 8, further comprising reporting to the second media device in real time once the user is provided with the discount associated with the unique discount code.

10. The method of claim 9, wherein the vendor is an online retailer or brick and mortar retailer.

11. The method of claim 9, wherein the vendor is an online retailer.

12. The method of claim 9, wherein the discount associated with the unique discount code is for purchasing digital media, physical merchandise, or a combination thereof.

13. The method of claim 9, wherein the unique discount code is for purchasing digital media from a brick and mortar retailer that is subsequently communicated to the user's media device.

14. The method of claim 9, wherein the unique discount code is for purchasing digital media from an online retailer that is communicated in real time upon completion of the purchase to the user's media device.
